(19) United States
(12) Patent Application Publication
(10) Pub. No.: US 2016/0367893 A1
(43) Pub. Date: Dec. 22, 2016

(54) DIGITAL CONTENT CREATION

(71) Applicant: DELUXE MEDIA CREATIVE SERVICES INC., Burbank, CO (US)

(72) Inventors: Peter SHIPKOV, Marina Del Rey, CA (US); Malte WAGENER, Los Angeles, CA (US)

(21) Appl. No.: 15/185,548

(22) Filed: Jun. 17, 2016

Related U.S. Application Data
(60) Provisional application No. 62/182,353, filed on Jun. 19, 2015.

(51) Int. Cl. A63F 13/25; G06T 19/00

(52) U.S. Cl. CPC A63F 13/25; G06T 19/006; A63F 2300/8082

(57) ABSTRACT

The present disclosure is directed to systems, devices, methods and processes for automatically transporting data from a content creation application to a game engine.

### CROSS-REFERENCE TO RELATED APPLICATIONS

This application claims the benefit of U.S. Provisional Application No. 62/182,353 filed on Jun. 19, 2015 entitled “Digital Content Creation”, which is hereby incorporated by reference in its entirety.

### FIELD

The present disclosure relates generally to systems and methods for digital content creation. More particularly, the present disclosure relates to systems, devices, methods and processes for transporting data from a content creation application to a graphics engine.

### BACKGROUND

The design of certain digital content such as game levels or three dimensional images typically occurs in a separate computing environment from the computing environment in which the digital content is rendered or displayed. In the gaming context, digital scenes that make up various game levels are typically created through a content creation application that is separate from the gaming engine that generates and displays the game. Because these different computing environments may include different languages or data structures, the process of converting a digital scene to a functional game level can be cumbersome. Specifically, numerous manual re-coding and re-writing steps are untaken before a working game level is produced. These manual steps can be cumbersome and time consuming and thus can add delays and additional costs to the process of producing a final product.

### BRIEF DESCRIPTION OF THE DRAWINGS

The accompanying drawings, which are incorporated in and constitute a part of the specification, illustrate examples of the disclosure and, together with the general description given above and the detailed description given below, serve to explain the principles of these examples.

FIG. 1 is a schematic illustration of a computer system configured to implement one or more aspects of the present disclosure.

FIG. 2 is a flow chart that illustrates a method in accordance with at least one embodiment of the present disclosure.

FIG. 3 is a flow diagram that illustrates a flow of various data elements that occurs in connection with the execution of a translator in accordance with the present disclosure.

FIG. 4 is a flow chart that illustrates another method in accordance with at least one embodiment of the present disclosure.

FIG. 5 is a graphical illustration of example output from a graphical user interface in accordance with the present disclosure.

### DETAILED DESCRIPTION

The present disclosure is directed to systems, devices, methods and processes for automatically transporting data from a content creation application to a graphics engine. Data representing assembled digital scenes may be exported from the content creation application through the operation of a translator. The translator may be generally configured to export the scene data and to covert the data for use in the graphics engine. The graphics engine may be generally configured generate graphics output through a graphics card or processor. In one embodiment, the graphics engine provides output in a three dimension (3D) representation. In this disclosure, certain implantations may be described that include the graphics engine implemented as a game engine. A game engine used in such implementations may be generally configured to provide video game output in the form of a various video game levels that may be played by a user. However, it should be appreciated that the present disclosure in not limited to the video game context. In accordance with other embodiments, the graphics engine may provide output for digital image rendering, virtual reality generation, and so on.

Once the translator converts data from the content creation application, the data may be sandboxed or otherwise stored as a game level or as another graphics element and later used by the game engine or other application. In some embodiments, a live link may be established between the content creation application and the game engine that allows changes to scenes that are made in the content creation application to be dynamically reflected by changes in corresponding game levels output by the game engine. Such changes may occur in “real time” in the sense may observe the changes in game engine output as the changes are made through the content creation application.

A live link in accordance with this disclosure may include an open network connection across which two more nodes communicate. Nodes may be provided in a client server arrangement where one node listens on a network socket for data sent out by another node. More specifically, one or more nodes associated with the game engine may listen for data sent out from one or more nodes associated with the content creation application. Once data is received across this network connection, the data may be processed and graphical output may be provided by the game engine. Because one or more nodes associated with the game engine may be continually listening for data, the game engine and the content creation application may be linked across the network connection such that scene changes or updates made in the content creation application may be propagated to the graphical output of the game engine.

Through the use of a live link and other features disclosed herein, present embodiments create content that is visible to an artist in its final form as the content is being created. Prior content creation processes are unable to provide this same level visibility of the final product at early creation stages. Specifically, prior processes typically involved an iterative process of creating scenes in a content creation environment, moving those scenes to a graphical output environment, observing the graphical output and determining what changes need to be made, and then starting again in the content creation environment. A trial and error approach was typically taken with these processes because of the limitations of the content creation application. While content creation applications have a high capacity for scene building and other authoring steps, the graphical output from the content creation application tends to be somewhat flat or two dimensional (2D) in appearance. Thus, artists were typically required to visualize or perhaps guess what the three dimensional (3D) end-product would ultimately look like. This guesswork would lead to errors in graphical output that would only become apparent after a cumbersome process of moving to the graphical environment had already taken place. Hence, the need to begin again at the content creation level. By providing a visual representation at early content creation stages through a live link to the graphics engine, present embodiments avoid this iterative, trial and error process that characterizes prior content creation schemes.

It is to be appreciated that the data conversion, graphics rendering, and other technologies disclosed herein may be suitable for implementation on specially configured computers. It is to be further appreciated that the various embodiments described herein may use specially configured computers as well, for example, digital multimedia data processing systems. Examples of digital multimedia data processing systems on which the various embodiments disclosed herein are intended to operate include, but are not limited to, multiple processor systems having hardware acceleration capacity.

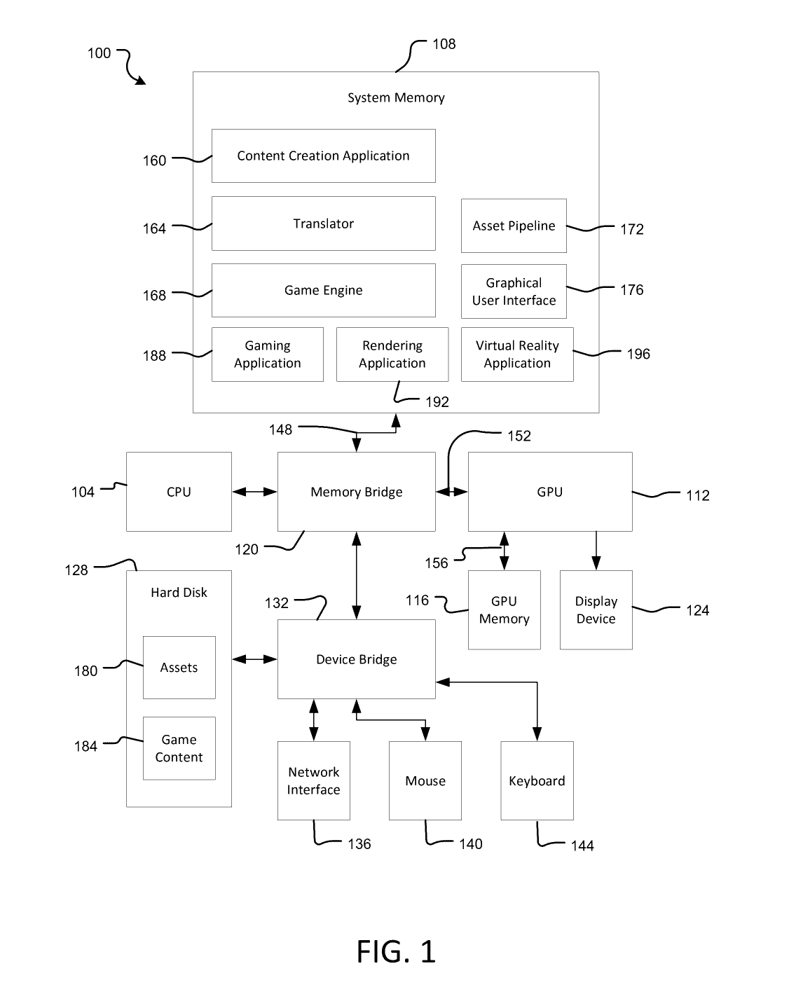

FIG. 1 illustrates a computer system 100 configured to implement one or more aspects of the present disclosure. The computer system 100 may include, without limitation, one or more processors or central processing units (CPU) 104, a system memory 108, a graphics processing unit (GPU) 112, a GPU memory 116, a memory bridge 120, a display device 124, a hard disk 128, a device bridge 132, a network interface 136, a mouse 140, and a keyboard 144.

The CPU 104 communicates with the system memory 108 via the memory bridge 120. In some embodiments, the memory bridge 120 may be a northbridge device or subsystem. The system memory 108 may be configured to store application programs, as well as data used by or generated by the CPU 104. The system memory 108 may be coupled to the memory bridge 120 via a system memory bus 148. The memory bridge 120 may be coupled to the GPU 112 via a GPU system bus 152. The GPU system bus 152 may comprise any technically feasible data interconnect, such as the personal computer interconnect (PCI) express bus. The memory bridge 120 may also be coupled to the device bridge 132 using an interconnect system such as PCI. The GPU 112 may include real time image rendering mechanisms for rendering both three-dimensional (3D) and two-dimensional (2D) images. The GPU 112 delivers pixel data to display device 124, which may comprise a CRT or LCD display. The GPU 112 may couple to the GPU memory 116 using a GPU memory bus 156. The GPU memory 116 may be configured to store data used by or generated by the GPU 112. Data stored within the GPU memory 116 passes through the GPU 112 and the memory bridge 120 when accessed by the CPU 104. In some embodiments, the integrated circuit implementing the CPU 104 may incorporate additional functional blocks, such as the memory bridge 120 and the device bridge 132. In alternative embodiments, the integrated circuit implementing the GPU 112 may incorporate additional functional blocks, such as the memory bridge 120 and the device bridge 132.

The device bridge 132 may couple to a hard drive 128, a network interface 136, a mouse 140, and a keyboard 144. The hard drive 128 provides mass storage of programs and data. The network interface 136 provides network connectivity to other computers using a local area network (LAN) interface using any suitable technology, such as Ethernet. The mouse 140 and keyboard 144 provide user input. Other components including USB or other port connections, CD drives, DVD drives, film recording devices, and the like, may also be connected to I/O bridge 132. Communication paths interconnecting the various components in FIG. 1 may be implemented using any suitable protocols, such as PCI (Peripheral Component Interconnect), PCI Express (PCI-E), AGP (Accelerated Graphics Port), HyperTransport, Quick Path Interconnect, or any other bus or point-to-point communication protocol(s), and connections between different devices may use different protocols as is known in the art.

In one embodiment, the system memory 110 is configured to store a content creation application 160, a translator 164, and a game engine 168, each of which may execute on the processor 104 to perform various functions described herein. The content creation application 160 is generally configured to provide a design environment in which an artist or other user may construct scenes or other content for use in a gaming environment. By way of example and not limitation, the content creation application 160 may be implemented as Maya, which is a 3D graphics software developed by Autodesk, Inc. Other 3D graphics software packages may be used depending on the implementation. The content creation application 160 may be provided in association with a graphical user interface 176 through which the artist or other user may provide design inputs for constructing various digital scenes. When assembled together, the various digital scenes constructed though the operation of the content creation application 160 may form game content that is executable through the operation of the game engine 168. For example, the content creation application 160 may be used to create various levels of a video game. When a game level is loaded into the game engine 168, the game engine 168 may provide video game output to the GPU 112 and from there to the display device 124. A game user may explore the game levels or otherwise interact with the video game through control inputs entered through input devices such as the mouse 140 or keyboard 144.

The translator 164 may be generally configured to transport scene data out of the content creation application 160 for use by the gaming engine 168. Here, the translator 164 may be configured to automatically analyze scene data in the content creation application 160 and to translate the scene data into a data format usable by the game engine 168. In order to facilitate this translation process, the translator 164 may be associated with an asset pipeline 172 that provides certain pre-defined assets 180 for use within the content creation application 160. The asset pipeline 172 may define a comprehensive set of rules for the assets 180. By way of example, the asset pipeline 172 may define rules that specify how the assets 180 should be authored, definitions that specify structure and naming conventions for the assets 180, addresses that specify file server or other locations for the assets 180, and so on. In order to further facilitate the translation process executed by the translator 164, the graphical user interface 176 may include a tool set that is adapted to work with the predefined assets 180. Through the use of the tool set, an artist or other user may manipulate the predefined assets 180 to form scenes in the content creation application 160. Scenes formed in this way may include parts of a movie, portions of virtual reality experience, game levels, and so on. Because the scenes are constructed using predefined formats that are recognized by the translator 164, the translator 164 may quickly and efficiently export the scenes out of the content creation application 160.

Once the translator 164 exports scene data out of the content creation application 160, the translator 164 may convert the scene data into game content 184. For example, the translator 164 may construct one or more game levels based on the scene data. The game levels may represent content that is the same that is authored within the content creation application, but yet executable within the gaming environment provided by the game engine 168. In one embodiment, the game engine 168 is configured to execute a three dimensional (3D) environment. In this context, the translator 164 may convert from two dimensional (2D) representations provided in the content creation application 160 into an interactive 3D environment provided by the game engine 168. As described in greater detail below, a live link may be established between the content creation application 160 and the game engine 168 that allows game content executing on the game engine 168 to be dynamically changed through the operation of the content creation application 160. In this way, an artist may observe changes to game content in real time, as he or she is making the changes.

Once the translator 164 has converted the scene data into game content 184, the game content 184 may be “sandboxed” or otherwise stored for later use. In some instances, the game content 184 may be exported out of the content creation application 160 and sandboxed without further alternation. In other instances, the game content 184 may be exported out of the content creation application 160, dynamically changed through a live link between the content creation application 160 and the game engine 168, and then sandboxed once the artist is satisfied with his or her changes. Once the game content 184 is sandboxed, it may be later recalled for use by one or more different applications. Sandboxed game content 184 may be incorporated as a game level or a portion of a game level that is executable by a gaming application 188. Here, the gaming application 188 may load the game content 184 into the game engine 168 and execute as appropriate. A rendering application 192 may also load the sandboxed game content 184 and render the content 184 as a digital image or movie scene. In other instances, a virtual reality application 196 may load the sandboxed game content 184 and display the content 184 as a virtual reality experience.

In an alternative embodiment, a first computer system includes content creation application 160 and a translator 164. Additionally, a set of one or more computer systems may include at least one instance of the game engine 168. In this scenario, the set of one or more computer systems is configured to communicate via a computer network. In this embodiment, the first computer system includes software configured to cause each computer system in the set of one or more computer systems to independently render and store scene segments.

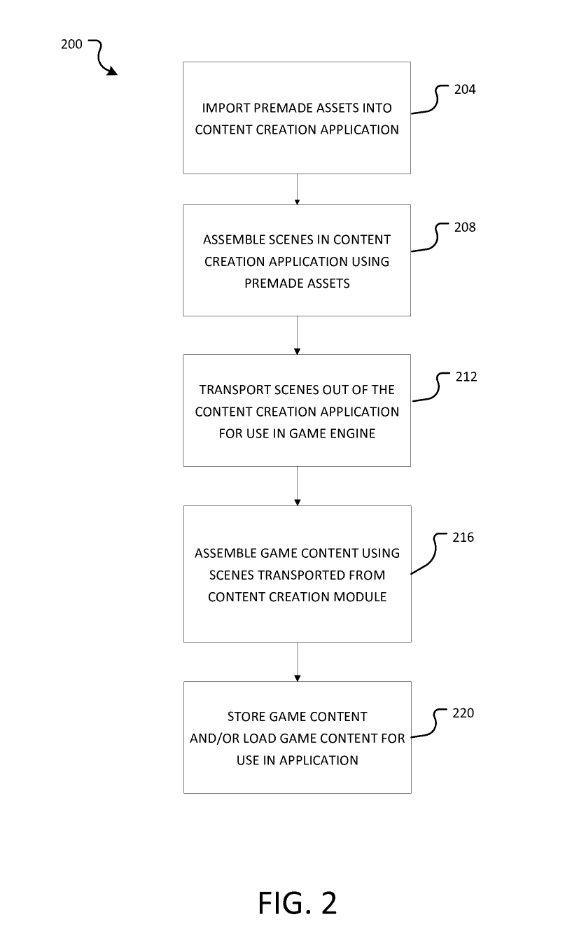

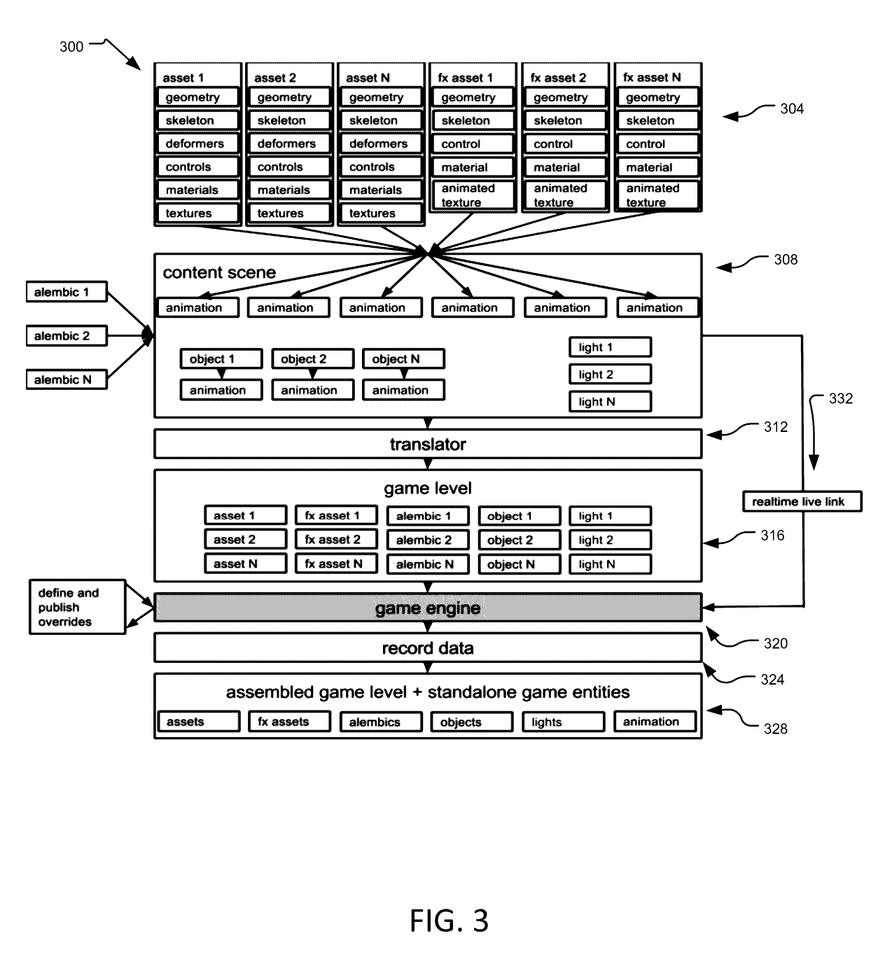

Aspects of the translator 164 and other components illustrated in FIG. 1 are further elaborated with reference to the flow chart 200 shown in FIG. 2. Flow chart 200 illustrates a method in accordance with at least one embodiment of the present disclosure. The method illustrated by flow chart 200 may be performed by the translator 164 and/or other applications of FIG. 1 as the applications execute on the processor 104. In the following discussion of flow chart 200, reference is additionally made to the flow diagram 300 shown in FIG. 3. Flow diagram 300 illustrates a flow of various data elements that occurs in connection with the execution of the translator 164 and/or other applications shown in FIG. 1.

Initially, in operation 204, premade assets 180 are imported into the content creation application 160. Here, the asset pipeline 172 may transfer one or more assets 180 from a hard disk 180 or other long term storage into the content creation application 160 for use by an artist or other user. An asset 180 may represent various objects or figures in a given scene. By way of example, an asset 180 may represent a human, a monster, a desk, a vehicle such as a tank or an airplane, and so on. An asset 180 may be defined by various properties and features such as geometries, skeletons, deformers, animation controls, textures, materials, and so on. Example assets that may be loaded into the content creation application 160 are shown in FIG. 3 and generally indicated with reference numeral 304.

In operation 208, scenes are assembled in the content creation application 160 using the predefined assets 180. Here, an artist or other user may provide design inputs through a graphical user interface 176. Through the graphical user interface 176, the user may create content through such actions as assigning shades, defining textures, applying materials, setting the general look or appearance of objects, and so on. Through these inputs, the artist or other user may create one or more scenes representing game levels, parts of a movie, portions of a virtual reality experience, or the like. Here, the artist or other user may make use of a specific tool set in the graphical user interface 176 that is adapted for use with the predefined assets 180. An example scene created with various predefined assets is shown in FIG. 3 and generally indicated with reference numeral 308.

In operation 212, scene data is transported out of the content creation application 160 for use in the game engine 168. Here, the translator 164 automatically analyzes scene data in the content creation application 160. Analyzing scene data may include such operations as converting textures into a particular format, converting bit depths from one format to another, moving or manipulating such elements as skin clusters, deformers, materials, and so on. These processes may occur quickly and efficiently because the scenes are constructed using predefined formats that are recognized by the translator 164. The process of transporting scene data out of the content creation application 160 is shown in FIG. 3 and generally identified with reference number 312.

In operation 216, game content 184 is assembled using scenes transported from the content creation application 160. Here, the translator 164 translates scene data into a data format usable by the game engine 168. In one example, the game content 184 assembled by the translator 164 takes the form of one or more game levels. The game content 184 may be an interactive, 3D version of the scene that was created by the user in the content creation application. The process of assembling game content is shown in FIG. 3 and is generally identified with reference number 320.

In operation 220, game content 184 is stored and/or loaded for use in an additional application. Here, the translator 164 stores the game content 184 for later recall and use by one or more additional applications. This storage process is generally referred to as “sandboxing.” In some examples, the game content 184 may include one or more game levels that can recalled and executed by a gaming application 188. In another example, the game content 184 may be recalled by a rendering application 192 that renders the content 184 as a digital image or a movie scene. In still another example, the game content 184 may be recalled by a virtual reality application 196 that displays the content 184 as a virtual reality experience. In FIG. 3, the process of storing or “sandboxing” the game content is indicated with reference number 324. The game content stored as part of a stand-alone application is indicated with reference number 328.

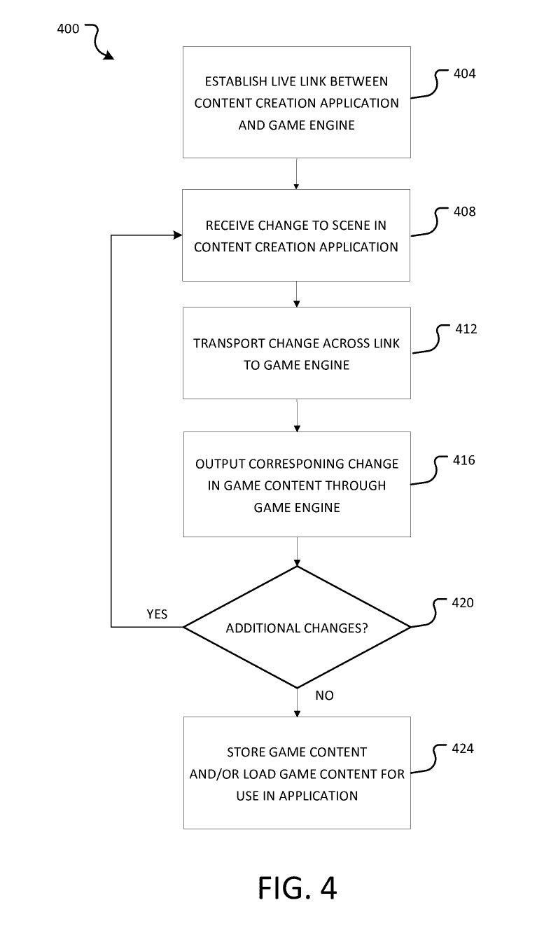

FIG. 3 additionally shows a process of establishing a live link between the content creation application 160 and the gaming engine 168. This process is generally indicated with reference number 332. As mentioned, such a live link between the content creation application 160 and the gaming engine 168 may be used to dynamically change game content 184 that is displayed by the game engine 168. These changes may reflect design changes that are input through the content creation engine 168. In this way, an artist may see the action of the final 3D product as he or she designs or changes the various scenes that make up the final product through the operation of the content creation application 160. This dynamic process is described in greater detail with reference to FIG. 4.

FIG. 4 is a flow chart 400 that illustrates another method in accordance with at least one embodiment of the present disclosure. Initially, in operation 404, a live link is established between the content creation application 160 and the game engine 168. In one embodiment, the live link includes nodes or contexts in the gaming environment that act as network clients. These network clients may be associated with one or more servers that are components of the content creation application 160. Here, the network clients listen on designated network sockets for changes that occur in the content creation application 160.

In operation 408, a change to a scene is received in the content creation application 160. Here, an artist or other user inputs the design change through a graphical user interface 176 or other appropriate mechanism. As mentioned, the artist may utilize a specific tool set in the graphical user interface 176 to construct or change a scene that is assembled from pre-defined assets 180.

In operation 412, the change is transported across the live link from the content creation application 160 to the game engine 168. Here, the translator 164 analyzes scene data representing the change, exports the data from the content creation application 160, and compiles game content using the exported data. Moreover, these operations occur across the live link such that the change input through the content creation application 160 is dynamically reflected in real time in the output provided by the game engine 168. Thus, in operation 416, a corresponding change is output in the game content that is output through game engine 168. In one embodiment, this live link transmission occurs by data that the transmitted from a server associated with the content creation application 160 being received via a client associated with the game engine 168.

In operation 420, a determination is made as to whether or not additional changes are to be made to the game content. If additional changes are to be made, the live link between the content creation application 160 and the game engine 168 remains in place. Here, operation 408 is again executed such that the artist or other user may input additional changes through the content creation application 160. If no additional changes are to be made, the live link between the content creation application 160 and the game engine 168 may be severed. Here, operation 424 may executed such that the game content 184 is stored for later use by an additional application. As mentioned, the stored game content 184 may be recalled for use by a gaming application 188, a rendering application 192, a virtual reality application 196, and so on.

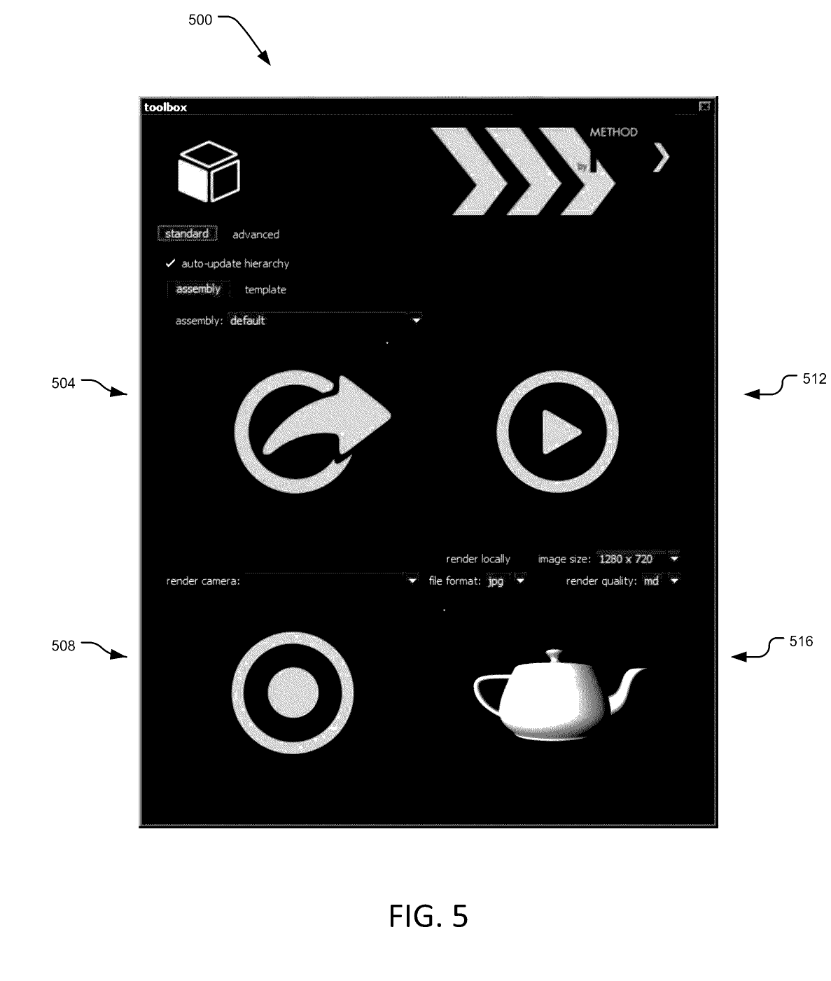

FIG. 5 is graphical illustration of example output 500 from a graphical user interface 176 in accordance with the present disclosure. The example output 500 includes various buttons that implement various features discussed herein. The example output 500 includes a first button 504 that when pressed causes scene data to be exported from the content creation application 160 to the game engine 168. The example output 500 includes a second button 512 that when pressed causes gaming engine 168 to engage using stored game content 184. The example output 500 includes a third button 508 that imports an asset such as a camera to be imported into the gaming engine 168. The example output 500 includes a fourth button 516 that when pressed causes a particular object to be imported into the gaming engine 168.

This disclosure describes certain implantations in the context of a game engine. A game engine used in such implementations may be generally configured to provide video game output in the form of various video game levels that may be played by a user. However, it should be appreciated that the present disclosure in not limited to the video game context. In accordance with other embodiments, a graphics engine may be provided that generates output for digital image rendering, virtual reality generation, and so on.

The above specification, examples and data provide a complete description of the structure and use of exemplary embodiments of the invention as defined in the claims. Although various embodiments of the claimed invention have been described above with a certain degree of particularity, or with reference to one or more individual embodiments, those skilled in the art could make numerous alterations to the disclosed embodiments without departing from the spirit or scope of the claimed invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

The foregoing description has broad application. The discussion of any embodiment is meant only to be explanatory and is not intended to suggest that the scope of the disclosure, including the claims, is limited to these examples. In other words, while illustrative embodiments of the disclosure have been described in detail herein, the inventive concepts may be otherwise variously embodied and employed, and the appended claims are intended to be construed to include such variations, except as limited by the prior art.

The foregoing discussion has been presented for purposes of illustration and description and is not intended to limit the disclosure to the form or forms disclosed herein. For example, various features of the disclosure are grouped together in one or more aspects, embodiments, or configurations for the purpose of streamlining the disclosure. However, various features of the certain aspects, embodiments, or configurations of the disclosure may be combined in alternate aspects, embodiments, or configurations. Moreover, the following claims are hereby incorporated into this Detailed Description by this reference, with each claim standing on its own as a separate embodiment of the present disclosure.

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present disclosure, and do not create limitations, particularly as to the position, orientation, or use. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Identification references (e.g., primary, secondary, first, second, third, fourth, etc.) are not intended to connote importance or priority, but are used to distinguish one feature from another. The drawings are for purposes of illustration only and the dimensions, positions, order and relative sizes reflected in the drawings attached hereto may vary.

1. A method of providing digital content, comprising:
assembling scenes in a content creation application;
transporting the scenes out of the content creation application for use in a game engine;
assembling game content using the scenes transported out of the content creation application.

2. The method of claim 1, further comprising:
establishing a live link between the content rendering application and the game engine;
receiving changes to scene data at the content creation application;
automatically transmitting the changes across the live link; and
implementing corresponding changes in the game content output by the game engine.

3. The method of claim 1, further comprising:
importing predefined assets into the content creation application;
wherein the operation of assembling scenes in the content creation application includes using the predefined assets.

4. The method of claim 1, further comprising:
storing the game content for later use by a gaming application that uses the game engine.

5. The method of claim 1, further comprising:
storing the game content for later use by a rendering application.

6. The method of claim 1, further comprising:
storing the game content for later use by a virtual reality application.

7. The method of claim 1, wherein the game content includes a plurality of levels.

8. The method of claim 1, further comprising:
establishing a live link between a content rendering application and a game engine;
receiving changes to scene data at the content creation application;
automatically transmitting the changes across the live link; and
implementing corresponding changes in a game content output by the game engine.

9. The method of claim 8, further comprising:
storing the game content for later use by a gaming application that uses the game engine.

10. The method of claim 8, further comprising:
storing the game content for later use by a rendering application.

11. The method of claim 8, further comprising:
storing the game content for later use by a virtual reality application.
